(19) United States
(12) Patent Application Publication
(10) Pub. No.: US 2023/0154033 A1
(43) Pub. Date: May 18, 2023

(54) METHOD AND DEVICE FOR ESTIMATING POSES AND MODELS OF OBJECT

(71) Applicant: SAMSUNG ELECTRONICS CO., LTD., Suwon-si (KR)

(72) Inventors: Paul OH, Seongnam-si (KR); Yamin MAO, Beijing (CN); Hongseok LEE, Seoul (KR); Qiang WANG, Beijing (CN); Yuntae KIM, Suwon-si (KR); Zhihua LIU, Beijing (CN)

(73) Assignee: SAMSUNG ELECTRONICS CO., LTD., Suwon-si (KR)

(21) Appl. No.: 17/944,326

(22) Filed: Sep. 14, 2022

(30) Foreign Application Priority Data
Nov. 12, 2021 (CN) 202111341686.7
Apr. 12, 2022 (KR) 10-2022-0045264

(51) Int. Cl. G06T 7/70; G06V 40/10; G06V 10/42; G06V 10/44; G06V 10/46

(52) U.S. Cl. CPC G06T 7/70; G06V 40/11; G06V 10/42; G06V 10/44; G06V 10/467; G06V 2201/07

(57) ABSTRACT

An object pose and model estimation method includes acquiring a global feature of an input image, and a location code of an object including location information for a joint point of the object and location information for a model vertex in a template model; determining a local area feature of the object based on the global feature of the input image and based on the location code of the object in the template model; and acquiring location information for the joint point of the object in the input image and location information for the model vertex in the input image based on the local area feature of the object.

### CROSS-REFERENCE TO RELATED APPLICATIONS

This application is based on and claims priority under 35 U.S.C. § 119 to Chinese Patent Application No. 202111341686.7, filed on Nov. 12, 2021, in the State Intellectual Property Office (SIPO) of the People's Republic of China and Korean Patent Application No. 10-2022-0045264, filed on Apr. 12, 2022, in the Korean Intellectual Property Office, the disclosures of which are incorporated by reference herein in their entireties.

### BACKGROUND

### 1. Field

The disclosure relates to the field of computer vision technology, and more particularly, to a method and device for estimating poses and models of an object.

### 2. Description of Related Art

Currently, techniques related to estimation of poses and models of human hands are primarily to learn the connection between the joint points of a hand part and the vertices of a model or the connection between the vertices of the model by chiefly shared global features and data driving methods.

In related art, the global features describe all regions of the hand part, but it is inappropriate to describe some positions of the hand part, such as joint points and the model vertices, as global features. This is mainly because the global features do not include location information and thus do not have partial discrimination power for feature information.

### SUMMARY

Provided are methods and devices for estimating poses and models of an object in order to improve the accuracy of the estimated poses and models of the object.

Additional aspects will be set forth in part in the description which follows and, in part, will be apparent from the description, or may be learned by practice of embodiments of the disclosure.

In accordance with an aspect of the disclosure, a method of estimating a pose of an object and a model of the object includes acquiring a global feature of an input image and a location code of an object in a template model, the location code including location information for a joint point of the object and location information for a model vertex; determining a local area feature of the object, based on the global feature of the input image and based on the location code of the object in the template model; and determining location information for the joint point of the object in the input image and location information for the model vertex in the input image, based on the local area feature of the object.

The determining of the local area feature of the object may include dividing the global feature into a plurality of sub-features that do not cross each other based on a local area of the object; and determining the local area feature of the object, based on the plurality of sub-features and based on the location code of the object in the template model.

The local area feature may include a feature representation of the joint point and the model vertex of the local area of the object.

The determining of the local area feature of the object may include acquiring the local area feature of the object by connecting the joint point in the local area corresponding to each sub-feature among the plurality of sub-features with coordinates of the model vertex.

The determining of the location information for the joint point of the object in the input image and the location information for the model vertex in the input image may include grouping local area features of the object into a plurality of groups of local area features based on positional relationships among local areas of the object; and determining the location information for the joint point of the object in the input image and the location information for the model vertex in the input image by performing encoding on the basis of a grouping result.

The grouping the local area features of the object based on the positional relationships among the local areas of the object may include encoding each local area feature of the local area features of the object through a first transformer network; and based on the positional relationship between the local areas of the object, acquiring the plurality of groups of features by grouping the encoded local area features.

The grouping of the encoded local area features based on the positional relationships among the local areas of the object may include grouping the encoded local area features according to a predetermined grouping rule based on the positional relationships among the local areas of the object, or grouping the encoded local area features through a grouping network based on the positional relationships between the local areas of the object.

The determining of the location information for the joint point of the object in the input image and the location information for the model vertex in the input image may include encoding each group of the plurality of groups of local area features through a second transformer network; and acquiring location information for at least one joint point of the object in the input image and location information for at least one model vertex in the input image by encoding the plurality of encoded groups of features through a third transformer network.

The object may include at least one of a human body, an animal, a part of the human body, and a part of the animal.

The part of the human body may include a hand part of the human body, and the local area of the object comprises at least one of a palm, a thumb, a forefinger, a middle finger, a ring finger, and a little finger.

In accordance with an aspect of the disclosure, a device for estimating a pose of an object and a model of the object includes a data acquisition device configured to acquire a global feature of an input image and a location code of an object in a template model, wherein the location code includes location information for a joint point of the object and location information for a model vertex of the object; a feature configuration device configured to determine a local area feature of of the object, based on the global feature of the input image and based on the location code of the object in the template model; and an estimation device configured to acquire location information for the joint point of the object in the input image and location information for the model vertex in the input image, based on the local area feature of the object.

The feature configuration device may be configured to divide the global feature into a plurality of sub-features, which do not cross each other, based on a local area of the object; and configure the local area feature of the object, based on the plurality of sub-features and based on the location code of the object in the template model.

The local area feature may include a feature representation of the joint point and the model vertex in the local area of the object.

The feature configuration device may be configured to acquire the local area feature of the object by connecting each sub-feature among the plurality of sub-features with coordinates of the joint point and the model vertex in a respective local area of the object, the respective local area corresponding to the sub-feature.

The estimation device may be configured to group local area features of the object into a plurality of groups of local area features based on positional relationships among the local areas of the object, and determine the location information for the joint point of the object in the input image and the location information for the model vertex in the input image by performing encoding on the basis of a grouping result.

The estimation device may be configured to encode each local area feature of the local area features of the object through a first transformer network, and acquire the plurality of groups of features by grouping the encoded local area features, based on a relationship between local areas of the object.

The estimation device may be configured to group the encoded local area features according to a predetermined grouping rule based on positional relationships among the local areas of the object, or group the encoded local area features through a grouping network based on the positional relationships between the local areas of the object.

The estimation device may be configured to encode each group of the plurality of groups of local area features through a second transformer network, and acquire location information for at least one joint point of the object and location information for at least one model vertex in the input image by encoding the plurality of encoded groups of features through a third transformer network.

The object may include at least one of a human body, an animal, a part of the human body, and a part of the animal.

The part of the human body may include a hand part of the human body, and the local area of the object comprises at least one of a palm, a thumb, a forefinger, a middle finger, a ring finger, and a little finger.

Throughout the following description, all aspects and other aspects and/or advantages of the disclosure will be described in part, some of which may be obvious in the description, or may be known through the execution of the entire disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a flowchart illustrating a method of estimating a pose and a model of an object, according to an embodiment;

FIG. 2 is a flowchart illustrating a method of estimating a pose and a model of a hand, according to an embodiment;

FIG. 3 is a diagram illustrating the correspondence relationship between the entire feature and a hand portion area;

FIG. 4A is a schematic diagram of a network for grouping local area features, according to an embodiment;

FIG. 4B is a diagram illustrating a process of visualizing a learnable grouping, according to an embodiment;

FIG. 5 is a block diagram illustrating a device of estimating a pose and a model of an object, according to an embodiment;

FIG. 6 is a block diagram illustrating a computer device according to an embodiment;

FIG. 7 is a perspective view illustrating a device for estimating a pose and a model of an object, which is applied to a wearable electronic device, according to an embodiment;

FIG. 8 is a perspective view illustrating a device for estimating a pose and a model of an object, which is applied to a wearable electronic device, according to an embodiment; and

FIG. 9 is a perspective view illustrating a device for estimating a pose and a model of an object, which is applied to a wearable electronic device, according to an embodiment.

### DETAILED DESCRIPTION

Reference will now be made in detail to embodiments, examples of which are illustrated in the accompanying drawings, wherein like reference numerals refer to like elements throughout. In this regard, embodiments may have different forms and should not be construed as being limited to the descriptions set forth herein. Accordingly, embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Reference will now be made in detail to embodiments of the disclosure shown in the drawings, wherein like numerals refer to like elements. Hereinafter, for convenience of description, the disclosure will be described with reference to the drawings.

The disclosure presents a method of encoding different areas of an object into different features, dividing the global feature into continuous sub-vectors, and making the divided sub-vectors correspond to the local locations of the hand. A feature representation of each joint point and model vertex is acquired by connecting the sub-vector to the location code in a channel direction. The representation of each local of the hand is transmitted to six different transformer networks on a first layer, respectively, to acquire collected features. In addition, in order to strengthen the connection relationship between hand part areas, the disclosure presents a grouping method based on data driving. Based on this new grouping method, the collected features are input to a second layer transformer network, respectively, to acquire features of the respective joint points and model vertices, and finally, all of the features are transmitted to a final transformer network to acquire 3D coordinates of at least one joint point and at least one model vertex.

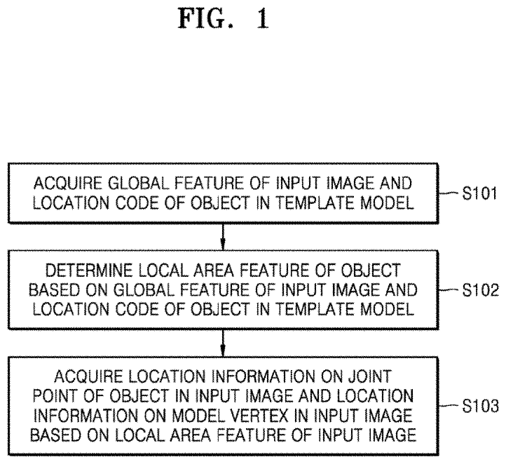

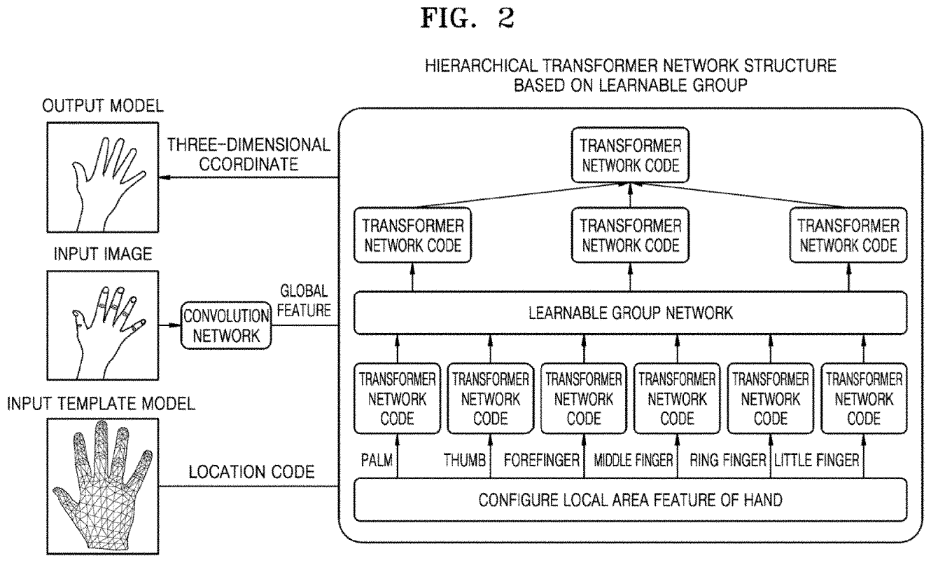

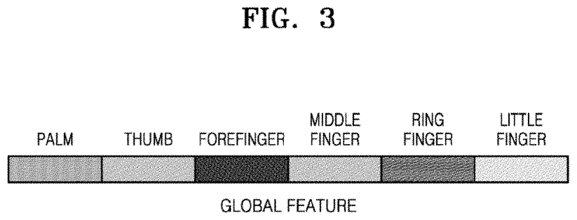

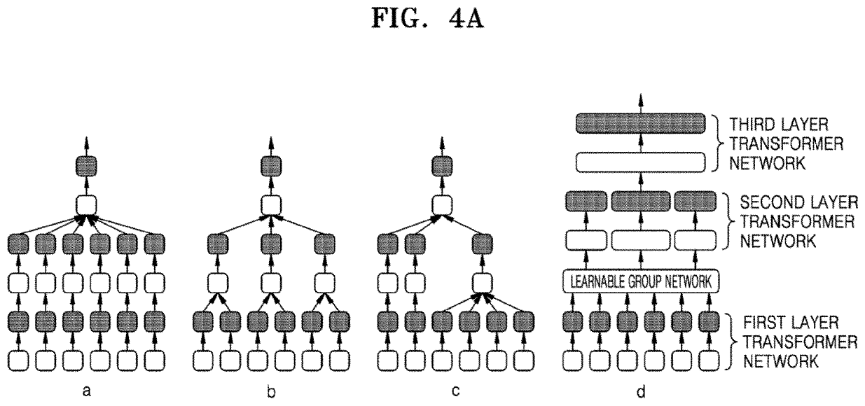

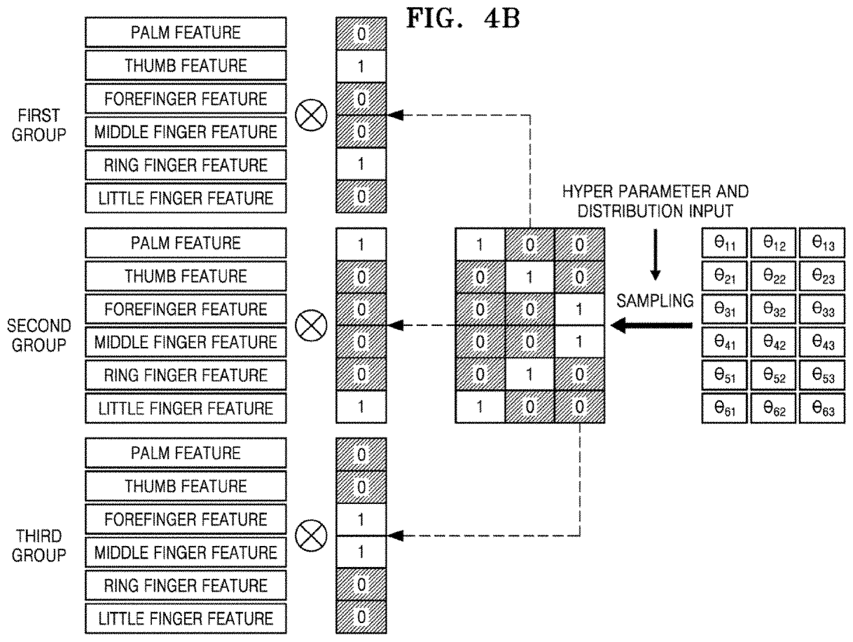

FIG. 1 is a flowchart illustrating a method of estimating a pose and a model of an object, according to an embodiment of the disclosure. FIG. 2 is a flowchart illustrating a method of estimating a pose and a model of a hand, according to an embodiment of the disclosure. FIG. 3 is a diagram illustrating the correspondence relationship between the entire area feature and a hand portion area. FIG. 4A is a schematic diagram of a network for grouping local area features, according to an embodiment of the disclosure. FIG. 4B is a diagram illustrating a process of visualizing a learnable grouping, according to an embodiment of the disclosure.

Referring to FIG. 1, in operation S101, a global feature (or ‘all-area feature’) of an input image and a location code of an object in a template model are acquired. Here, the location code includes location information of a joint point of the object and location information of a model vertex (e.g., the location information may include three-dimensional coordinates). The input image may be an image acquired using a monocular color sensor, and the template model may, for example, be acquired at a time in which the pose is zero and the shape is zero by an existing parameterization model, e.g., hand model with articulated and non-rigid deformations, briefly referred to as MANO.

In an example embodiment of the disclosure, the object may include at least one of a human body, an animal, a part of the human body, and a part of the animal. For example, the object may be a hand. When the object is a hand, the template model is a template model of the hand. In an example embodiment of the disclosure, a hand will be described as an example, but the disclosure is not limited thereto.

In an example embodiment of the disclosure, when a part of the human body includes a hand part of the human body, and the object is a hand part of the human body, the local area includes at least one of a palm, a thumb, a forefinger, a middle finger, a ring finger, and a little finger.

In an example embodiment of the disclosure, when acquiring the global feature of the input image, and the location code of the object in the template model, the input image and the template model of the object may be first acquired and then the global feature of the input image may be extracted, and the location code of the object in the template model may be determined on the basis of the template model of the object. For example, it is possible to extract global features of an input image through a convolutional neural network (CNN), or to extract global features of an input image through a backbone network.

For example, as shown in FIG. 2, when estimating a pose and a model of an object, an input may be a monocular color image and a template model of a hand, which may be things in which a global feature (which may be extracted via a CNN) of an input image acquired from the input monocular color image and the input template model of the hand, and a location code of a hand in the template model are input to a hierarchical transformer network based on learnable grouping. In FIG. 2, the hierarchical transformer network based on learnable grouping mainly includes two parts, of which a first part includes a module for configuring a local area feature of a hand and of which a second part includes a learnable grouping network. Each layer of the transformer network of FIG. 2 may include a mask network model to estimate a pose and a model of a hidden portion of an object.

In step S102, the local area feature of the object may be determined based on the global feature of the input image, and the location code of the object in the template model. For example, as shown in FIG. 2, different features may be configured for the local area of the hand. In FIG. 2, for example, the palm, thumb, forefinger, middle finger, ring finger, and little finger may be configured as local area features.

In the related art, when inputting all joint points and model vertices of a hand part into the transformer network, only the connection between the vertex and the joint point or between a vertex and another vertex may be learned in a data drive scheme but the geometric structure of the hand, such as the integrity of the finger, is not considered.

In an example embodiment of the disclosure, the local area features may include feature representations of joint points and model vertices in the local area.

In an example embodiment of the disclosure, when determining the local area feature of an object based on the global feature of the input image, and the location code of the object in the template model, first, the global feature may be divided into a plurality of sub-features that do not cross each other, based on the local area of the object, and then the local area feature of the object may be determined based on the plurality of sub-features and the location code of the object in the template model. For example, when the object is a hand, the local area may include a palm, a thumb, a forefinger, a middle finger, a ring finger, a little finger, and the like, and the sub-features may correspond to the local areas.

In an example embodiment of the disclosure, when determining the local area feature of the object, based on the plurality of sub-features and the location code of the object in the template model, each of the plurality of sub-features may be connected to coordinates of the joint point and the model vertex in a corresponding local area to acquire the local area feature of the object.

For example, as shown in FIG. 3, the plurality of sub-features corresponds to a palm, a thumb, a forefinger, a middle finger, a ring finger, and a little finger, respectively. Depending on the geometric structure of the hand, the hand may be divided into six non-crossing parts: the palm, thumb, forefinger, middle finger, ring finger, and little finger. In order to explain the local area of the hand with the global feature of the hand, the global feature is also divided into sub-features of six parts that do not intersect with each other, and the feature of each part corresponds to the local area of the hand. In addition, using the location code of each of the joint point and the model vertex in the template model, the sub-feature and the location code are connected in the channel direction. As described above, a description of the feature and position of each of the joint point and the model vertex in the sub-feature of the hand part is acquired. Accordingly, it may be seen that the numbers of joint points and model vertices included in each sub-feature may be different, which is determined by the geometric position.

For example, each of six parts of the hand may include 56, 32, 35, 35, 31, and 27 joint points and model vertices, respectively. Each point has a feature vector representation of 344 dimensions, in which the first 341 dimensions are semantic features, and the subsequent 3 dimensions are location codes. Vectors of the respective points of each part are input to the transformer network structure, and in this case, the transformer network structure does not share weights. Even a human body structure is divided into six parts such as the head, the left arm, the right arm, the chest, the left leg, and the right leg. For example, an existing parameterized human body model may be used as a template of the human body.

In step S103, the location information of the joint point of the object in the input image and the location information of the model vertex in the input image are acquired on the basis of the local area feature of the object.

In an example embodiment of the disclosure, when determining the pose and model of the object, based on the local area feature of the object, first, local area features are grouped based on the positional relationship between the local areas of the object, and then encoding is performed based on the grouping results to determine the location information of the joint point of the object in the input image and the location information of the model vertex in the input image.

In an example embodiment of the disclosure, when grouping local area features based on a positional relationship between local areas of the object, first, after encoding each local area feature using a first transformer network, a plurality of groups of features may be acquired by grouping the local area features encoded on the basis of the positional relationship between the local areas of the object.

In an example embodiment of the disclosure, when grouping the local area features encoded based on the positional relationship between the local areas of the object, the encoded local area features may be grouped according to a predetermined grouping rule based on the positional relationship between the local areas of the object, or the encoded local area features may be grouped through the grouping network based on the positional relationship between the local areas of the object.

In an example embodiment of the disclosure, when determining the location information of the joint point of the object in the input image and the location information of the model vertex in the input image by performing encoding according to the grouping result, first, location information regarding at least one joint point of the object and at least one model vertex in the input image may be acquired by encoding each group feature of the grouping result through a second transformer network and encoding the plurality of groups of features encoded through a third transformer network.

As shown in FIG. 2, different features, each configured for a local area of a hand, are input into an individual transformer network structure (corresponding to a first layer transformer network code of FIG. 2) to acquire a collected local area feature. In order to strengthen the positional relationship among the local areas, a learnable grouping module was configured as illustrated in FIG. 2, and features of each of the joint points and model vertices were acquired by inputting the learned grouping features into a second layer transformer network (corresponding to a second layer transformer network code of FIG. 2). Finally, all features (or at least one of these features) are transmitted to the last transformer network (corresponding to a third layer transformer network code of FIG. 2) to acquire 3D coordinates for the at least one joint point and the at least one model vertex. For example, as shown in FIG. 2, the output of a hierarchical transformer network based on learnable grouping is a 3D pose and model of a hand.

In addition, when grouping the local area features encoded based on the positional relationship between the local areas of the object, a hierarchical transformer network based on predetermined grouping rules may be used instead of learnable grouping. in FIG. 4A, structure (a) is a schematic diagram of an ungrouped hierarchical transformer network, structures (b) and (c) are schematic diagrams of a hierarchical transformer network based on a predetermined grouping rule, and structure (d) is a schematic diagram of a hierarchical transformer network based on learnable grouping. In FIG. 4A, each of the six elements along the bottom of the figures may correspond to the six local areas of the hand.

As shown in structure (a) of FIG. 4A, three-dimensional coordinates are predicted by transmitting at least one of a joint point and a model vertex as input to a transformer network of three layers.

As shown in structure (b) of FIG. 4A, a palm and a thumb are grouped into one group together, a forefinger and a middle finger are grouped into one group, and a ring finger and a little finger are grouped into one group.

As shown in structure (c) of FIG. 4A, the palm and the thumb become one group, and the remaining four fingers become one group. The last one figure is to illustrate a merge method based on learning.

As shown in structure (d) of FIG. 4A, grouping is performed through a learnable grouping network.

For example, it is assumed that G={G₁, G₂, G₃, G₄, G₅, G₆} is the output of the first layer transformer network structure, and G₁ represents the i-th sub feature of the hand, and includes all hand joint points and all model vertices in the sub feature. Each point is represented by a feature vector of dimension C. The goal of the learnable grouping module is to merge these six sub features into K features. (that is, G=Uⱼ₌₁^{K}Gⱼ′, wherein K<6).

Gⱼ′ consists of one binary selector (φᵢⱼ) and a sub feature (Gᵢ), and the newly configured sub feature cannot cross each other. All φᵢⱼ constitute ø, and the new subregion satisfies the condition of Equation 1.

$${G}_{j}^{′} = {\sum }_{i = 1}^{6} {G}_{i} ⊙ {φ}_{ij} ∀ ( i , j ) {G}_{j}^{′} {∩G}_{i}^{′} = ∅ \qquad [ Equation 1 ]$$

In Equation 1, ∀(i, j) may refer to any i, j.

The binary selector should satisfy the condition of Equation 2.

$$∀ i ∈ \{ 1 , … , 6 \} {\sum }_{j = 1}^{K} {φ}_{ij} = 1 , {φ}_{ij} ∈ \{ 0 , 1 \} \qquad [ Equation 2 ]$$

To allow the binary selector to perform differentiation, the conventional Gumbel-softmax method may be used to parameterize φᵢⱼ again. For example, φᵢⱼ may be parameterized again by Equation 3 below. In this way, the sampling result yᵢⱼ may be differentiated, and the slope may be returned during the network training process.

$${y}_{ij} = \frac{exp ( ( log ( {φ}_{ij} ) + {g}_{ij} ) / τ )}{{\sum }_{j = 1}^{k} exp ( ( log ( {φ}_{ij} ) + {g}_{ij} ) / τ )} \qquad [ Equation 3 ]$$

In Equation 3, gᵢⱼ denotes a sampling variable, yᵢⱼ denotes a sampling result, and T denotes a hyperparameter temperature.

As shown in FIG. 4B, assuming that six sub features are divided into three groups and a 6*3 matrix is randomly generated, an initial value of each element in the matrix is 0.5, which corresponds to a value of log(φᵢⱼ) in the above Equation 3. Next, gᵢⱼ, which is one variable is randomly generated. The variable follows the Gumbel (0,1) extreme value distribution. The hyper parameter temperature (τ) is defined as one fixed value, wherein T is close to zero. The sampling result is closer to the discrete distribution, and the larger T is, the closer the sampling result to the average value distribution. Here, ⊖₁₁ to ⊖₆₃ are the parameters of the sub feature.

In an object pose and model estimation method according to an example embodiment of the disclosure, first, a global feature of an input image, and a location code of an object in a template model are acquired, a local area feature of the object is configured on the basis of the global feature of the input image, and the location code of the object in the template model, and a pose and a model of the object are determined on the basis of the local area feature of the object, thereby improving the accuracy of the estimated pose and model of the object, reducing calculation parameters, and reducing calculation costs.

An object pose and model estimation method according to an example embodiment of the disclosure may be used in augmented reality (AR), virtual reality (VR), object interaction, and the like.

Furthermore, according to an example embodiment of the disclosure, a computer-readable medium storing a computer program capable of implementing a pose and model estimation method of an object, according to an example embodiment of the disclosure, when executed is further provided.

In an example embodiment of the disclosure, one or two programs are mounted on the computer-readable medium. When the computer program is executed, acquiring a global feature of an input image, and a location code of an object including coordinates of a joint point and a model vertex of the object in a template model, configuring a local area feature of the object based on the global feature of the input image, and the location code of the object in the template model, and determining a pose and a model of the object based on the local area feature of the object may be implemented.

Computer-readable media may be, for example, electric, magnetic, optical, electromagnetic, infrared, or semiconductor systems, devices or elements, or any combination thereof, but are not limited thereto. More specific examples of computer-readable media include electrical connections with one or more conducting wires, portable computer disks, hard disks, random access memory (RAM), read-only memory (ROM), erasable/programmable read-only memory (EPROM) or flash memory, optical fiber, portable compact disk read-only memory (CD-ROM), an optical memory device, a magnetic memory device, or any suitable combination of the foregoing, but are not limited thereto. In an embodiment of the disclosure, the computer-readable medium may be any type of medium including or storing a computer program, and the computer program may be used by a command execution system, device, or element, or a combination thereof. Any suitable medium capable of transmitting a computer program included in a computer-readable storage medium may include, but is not limited to, wires, optical cables, frequency (RF), or the like, or any suitable combination of the foregoing. Computer-readable storage media may be included in any device, or may exist separately and not be included in the device.

In addition, according to an example embodiment of the disclosure, a computer program product is further provided, including instructions that may be executed to complete an object pose and model estimation method according to an example embodiment of the disclosure.

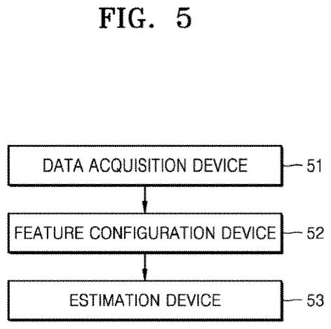

As described above, an object pose and model estimation method according to an example embodiment has been described with reference to FIGS. 1 to 4B. Hereinafter, an object pose and model estimation device, and units thereof according to an example embodiment of the disclosure will be described with reference to FIG. 5.

FIG. 5 is a block diagram illustrating a device of estimating a pose and a model of an object, according to an example embodiment of the disclosure.

Referring to FIG. 5, an object pose and model estimation device includes a data acquisition device 51, a feature configuration device 52, and an estimation device 53.

The data acquisition device 51 is configured to acquire the global feature of the input image and the location code of the object in the template model. Here, the location code may be location information on the joint point of the object and location information on the model vertex.

In an example embodiment of the disclosure, the object may include at least one of a human body, an animal, a part of the human body, and a part of the animal.

In an example embodiment of the disclosure, when a part of the human body includes a hand part of the human body, and the object is a hand part of the human body, the local area includes at least one of a palm, a thumb, a forefinger, a middle finger, a ring finger, and a little finger.

In an example embodiment of the disclosure, the data acquisition device 51 may acquire an input image and a template model of the object, extract a global feature of the input image, and determine a location code of the object in the template model based on the template model of the object.

The feature configuration device 52 is configured to determine the local area feature of the object according to the global feature of the input image, and the location code of the object in the template model.

In an example embodiment of the disclosure, the feature configuration device 52 may be configured to divide the global feature into a plurality of sub-features that do not intersect with each other based on the local area of the object, and configure the local area feature of the object based on the plurality of sub-features and the location code of the object in the template model.

In an example embodiment of the disclosure, the local area feature may include feature representations of joint points and model vertices in the local area.

In an example embodiment of the disclosure, the feature configuration device 52 may be configured to acquire a local area feature of the object by connecting each sub-feature of the plurality of sub-features with coordinates of a joint point and a model vertex of a corresponding local area.

The estimation device 53 is configured to acquire location information of the joint point of the object in the input image and the location information of the model vertex in the input image based on the local area feature of the object.

In an example embodiment of the disclosure, the estimation device 53 groups the local area features based on a positional relationship between the local areas of the object, performs encoding on the basis of the grouping result, and determines location information on the joint point of the object in the input image and location information on the model vertex in the input image.

In an example embodiment of the disclosure, the estimation device 53 may be configured to encode each local area feature via a first transformer network and to group the encoded local area feature based on the positional relationship between the local areas of the object to acquire various groups of features.

In an example embodiment of the disclosure, the estimation device 53 may be configured to group the encoded local area features according to a predetermined grouping rule based on a positional relationship between the local areas of the object, or group the encoded local area features in accordance with a grouping network based on a positional relationship between the local areas of the object.

In an example embodiment of the disclosure, the estimation device 53 may be configured to encode each group feature of grouping results via a second transformer network, acquire location information for the at least one joint point and at least one model vertex in the input image by encoding the plurality of encoded groups of features through a third transformer network.

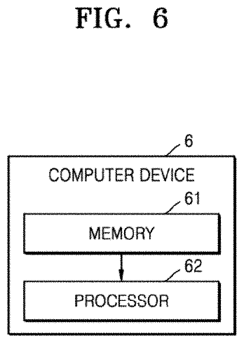

The pose and model estimation device of an object according to an example embodiment of the disclosure has been described with reference to FIG. 5. Next, a computer device according to an example embodiment will be described with reference to FIG. 6.

FIG. 6 is a block diagram illustrating a computer device according to an embodiment of the disclosure.

Referring to FIG. 6, a computer device 6 according to an example embodiment of the disclosure includes a memory 61 and a processor 62, the memory 61 storing a computer program capable of implementing an object pose and model estimation method according to an example embodiment of the disclosure when executed by the processor 62.

In an example embodiment of the disclosure, when the computer program is executed by the processor 62, acquiring a local feature of an input image, and a location code of an object including coordinates of a joint point and a model vertex of the object in a template model, configuring a local area feature of the object, based on the local feature of the input image and the location code of the object in the template model, and determining the pose and model of the object, based on the local area feature of the object, may be implemented.

In an embodiment of the disclosure, the computer device may include, but is not limited to, devices such as mobile phones, notebook computers, personal digital assistants (PDAs), tablet computers (PADs), desktop computers, wearable electronic devices (e.g., AR glasses). The computer device shown in FIG. 6 is merely an example and does not limit the function and use range of the embodiment of the disclosure.

As described above, an object pose and model estimation method and device according to an example embodiment of the disclosure has been described with reference to FIGS. 1 to 6. However, the object pose and model estimation device and the units thereof, which are shown in FIGS. 4 and 5 may be configured to execute software, hardware, firmware, or any combination of the items, each having a particular function. In addition, it is to be understood that the computer device shown in FIG. 6 is not limited to include the elements shown above, but some elements may be added or omitted as needed, and may be combined with one or more elements.

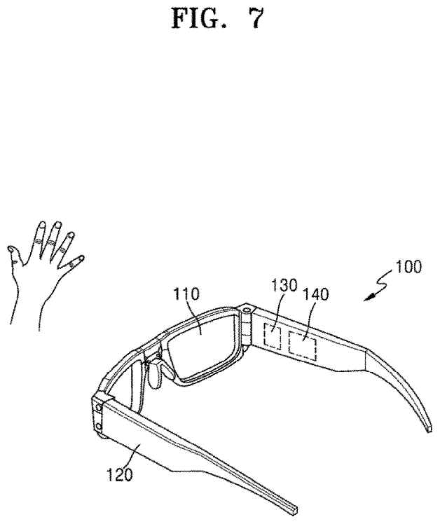

Hereinafter, a wearable electronic device to which the object pose and model estimation method or device of FIGS. 1 to 6 is applied will be described with reference to FIGS. 7 to 9.

FIG. 7 is a perspective view illustrating a device for estimating a pose and a model of an object, which is applied to a wearable electronic device, according to an embodiment of the disclosure.

Referring to FIG. 7, a wearable electronic device 100 according to an embodiment may include a lens 110, a connection unit 120 for fixing the wearable electronic device 100 to a part of a user's body (e.g., the head, etc.), a sensor 130, and a processor 140. The wearable electronic device 100 according to an embodiment may be an example of the computer device of FIG. 6, and a redundant description thereof will be omitted below.

According to an embodiment, the wearable electronic device 100 may be a glasses-type electronic device that may be worn on a user's ears, as shown in FIG. 7, but is not limited thereto. In another example, the wearable electronic device 100 may be a head-mount-type electronic device that may be worn on the user's head.

The sensor 130 may sense data about the peripheral environment of the wearable electronic device 100, and the data (or “sensing data”) sensed by the sensor 130 may be transmitted to the processor 140 that is electrically or operatively connected to the sensor 130. In this case, the sensor 130 may be at least a part of the data acquisition device 51 of FIG. 5.

In an example, the sensor 130 may include at least one of a camera, a color sensor, and a depth sensor for acquiring image data for a peripheral object of the wearable electronic device 100, but is not limited thereto. In another example, the sensor 130 may further include at least one of an inertial measurement unit (IMU), a global positioning system (GPS), and an odormeter.

The processor 140 may be electrically or operatively connected to the sensor 130, and may determine a pose and a model of an object located around the wearable electronic device 100, based on data sensed by the sensor 130.

According to an embodiment, the processor 140 may use image data for a peripheral object (e.g., a hand part of a human body) sensed by the sensor 130 as an input image to acquire location information about a joint point of the peripheral object in the input image and location information on a model vertex thereof. In this case, the processor 140 may serve as the feature configuration device 52 and/or the estimation device 53 of FIG. 5.

The processor 140 may acquire a global feature (or “all-area feature”) from the input image acquired by the sensor 130 and acquire a location code of the peripheral object from a template model stored in the memory. For example, the memory may store a template model including a parameterization model (e.g., MMO), and the processor 140 may be electrically or operatively connected to the memory to acquire a location code including the location information of the joint point of the peripheral object and the location information of the model vertex from the template model stored in the memory. The memory may be a separate element that is distinct from the processor 140, but is not limited thereto. According to an embodiment, the memory may be integrated with the processor 140 formed therein or may be embedded in the processor 140.

In this case, an operation of acquiring a global feature from the above-described input image of the processor 140 and acquiring a location code of an object from the template model may be substantially the same as or similar to operation S101 of FIG. 1, and a redundant description thereof will be omitted below.

In addition, the processor 140 may determine a local area feature of the peripheral object, based on the global feature of the input image and the location code of the peripheral object in the template model. For example, the processor 140 may utilize the global feature of the input image and the location code of the peripheral object in the template model to determine the local area feature of the peripheral object including the feature representation of the joint point and model vertex in the local area of the peripheral object.

In this case, an operation of determining a local area feature of the peripheral object of the processor 140 may be substantially the same as or similar to operation S102 of FIG. 1, and a redundant description thereof will be omitted below.

In addition, the processor 140 may acquire location information of the joint point of the peripheral object and location information of the model vertex in the input image, based on the local area feature of the peripheral object. For example, the processor 140 may group the local area features based on the positional relationship between the local areas of the peripheral object, and perform encoding based on the grouping results, thereby determining the location information of the joint point of the peripheral object in the input image and the location information of the model vertex in the input image.

In this case, an operation of acquiring the location information of the joint point and the location information of the model vertex of the peripheral object of the processor 140 may be substantially the same as or similar to operation S103 of FIG. 1, and redundant descriptions thereof will be omitted below.

According to an embodiment, the wearable electronic device 100 may generate an augmented reality image based on the location information of the joint point of the peripheral object and the location information of the model vertex, which have been determined through the operations of the processor 140, and display the generated augmented reality image through the lens 110 (or “display”).

In the disclosure, the “augmented reality image” may mean an image acquired by combining a real world image with a virtual image around the wearable electronic device 100. For example, the augmented reality image may refer to an image in which a virtual image is overlaid on a real world image, but is not limited thereto.

In this case, the real world image refers to a real scene that a user may see through the electronic device 100, and the real world image may include a real world object. In addition, the virtual image refers to an image formed by graphics processing that does not exist in a real world, and a digital or virtual object may be included in the virtual image.

According to an embodiment, the sensor 130 and the processor 140 may be arranged in the connection unit 120, as shown in FIG. 7, but the arrangement structure of the sensor 130 and the processor 140 is not limited thereto. In another embodiment, the sensor 130 and/or the processor 140 may be arranged in a peripheral area (e.g., an edge) of the lens 110.

The wearable electronic device 100 may further include optical components for emitting light including data for the augmented reality image and adjusting the movement path of the emitted light. The processor 140 may emit light including data on the augmented reality image through optical components, and allow the emitted light to reach the lens 110.

As the light including the data for the augmented reality image reaches the lens 110, the augmented reality image may be displayed on the lens 110, and the wearable electronic device 100 may provide the augmented reality image to the user (or the wearer) through the above-described process.

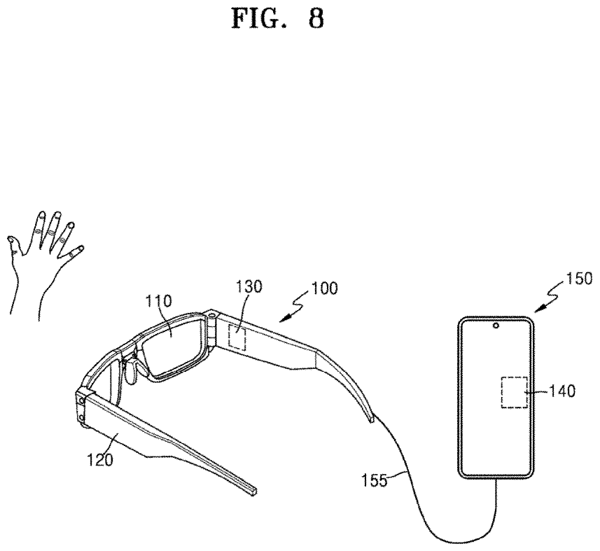

FIG. 8 is a perspective view illustrating a device for estimating a pose and a model of an object, which is applied to a wearable electronic device, according to an embodiment of the disclosure.

Referring to FIG. 8, the wearable electronic device 100 according to an embodiment may include a lens 110, a connection unit 120 for fixing the wearable electronic device 100 to a part (e.g., the head) of a user's body, and a sensor 130. At least one of the components of the wearable electronic device 100 according to an embodiment may be the same or similar to at least one of the components of the wearable electronic device 100 of FIG. 7, and the redundant descriptions thereof will be omitted below.

According to an embodiment, the wearable electronic device 100 may be electrically or operatively connected to an external device 150 (e.g., a mobile electronic device). For example, the wearable electronic device 100 may be connected by wire to the external device 150 through an interface 155, but is not limited thereto. In another example, the wearable electronic device 100 may be wirelessly connected to the external device 150 through wireless communication.

The external device 150 may include a processor 140, and the processor 140 may receive sensing data on the peripheral environment of the wearable electronic device 100 from the sensor 130 of the wearable electronic device 100. For example, the processor 140 may receive image data on a peripheral object of the wearable electronic device 100 from the sensor 130 through the interface 155.

The processor 140 of the external device 150 may acquire location information on a joint point of the peripheral object in the input image and location information on a model vertex by using image data on the peripheral object (e.g., a hand part of a human body) received from the sensor 130. In this case, the processor 140 of the external device 150 may serve as the feature configuration device 52 and/or the estimation device 53 of FIG. 5.

The processor 140 may acquire a global feature from an input image acquired by the sensor 130 of the wearable electronic device 100 and may acquire a location code of a peripheral object from a template model stored in a memory. In this case, the memory may store a template model including a parameterization model, such as MAMO, in a separate element distinguished from the processor 140, but is not limited thereto. According to an embodiment, the memory may be integrated with the processor 140 formed therein or may be embedded in the processor 140.

In this case, an operation of acquiring a global feature from the above-described input image of the processor 140 and acquiring a location code of an object from the template model may be substantially the same as or similar to operation S101 of FIG. 1, and a redundant description thereof will be omitted below.

In addition, the processor 140 may determine a local area feature of the peripheral object, based on the global feature of the input image and the location code of the peripheral object in the template model. For example, the processor 140 may utilize the global feature of the input image and the location code of the peripheral object in the template model to determine the local area feature of the peripheral object including the feature representation of the joint point and model vertex in the local area of the peripheral object.

In this case, an operation of determining a local area feature of the peripheral object of the processor 140 may be substantially the same as or similar to operation S102 of FIG. 1, and a redundant description thereof will be omitted below.

In addition, the processor 140 may acquire location information of the joint point of the peripheral object and location information of the model vertex in the input image, based on the local area feature of the peripheral object. For example, the processor 140 may group the local area features based on the positional relationship between the local areas of the peripheral object, and perform encoding based on the grouping results, thereby determining the location information of the joint point of the peripheral object in the input image and the location information of the model vertex in the input image.

In this case, an operation of acquiring the location information of the joint point and the location information of the model vertex of the peripheral object of the processor 140 may be substantially the same as or similar to operation S103 of FIG. 1, and redundant descriptions thereof will be omitted below.

According to an embodiment, the augmented reality image may be generated based on the location information of the joint point of the peripheral object and the location information of the model vertex, which are determined through the operations of the processor 140 of the external device 150, and the generated augmented reality image may be transmitted to the wearable electronic device 100. For example, the processor 140 may transmit, to the wearable electronic device 100 through the interface 155, the augmented reality image generated based on the location information of the joint point of the peripheral object of the wearable electronic device 100 and the location information of the model vertex thereof.

The wearable electronic device 100 may display the augmented reality image received from the external device 150 through the lens 110 (or “display”). The wearable electronic device 100 may further include optical components for emitting light including data for the augmented reality image and adjusting the movement path of the emitted light. The wearable electronic device 100 may emit light including data on the augmented reality image received from the external device 150 through optical components, and may allow the emitted light to reach the lens 110.

As the light including the data for the augmented reality image reaches the lens 110, the augmented reality image may be displayed on the lens 110, and the wearable electronic device 100 may provide the augmented reality image to the user (or the wearer) through the above-described process.

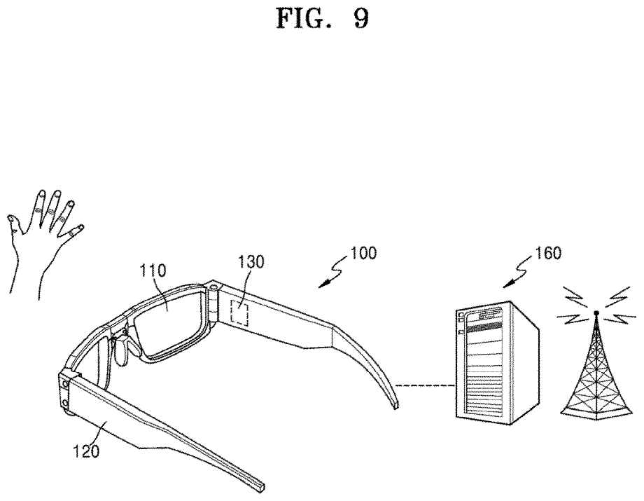

FIG. 9 is a perspective view illustrating a device for estimating a pose and a model of an object, which is applied to a wearable electronic device, according to an embodiment of the disclosure.

Referring to FIG. 9, the wearable electronic device 100 according to an embodiment may include a lens 110, a connection unit 120 for fixing the wearable electronic device 100 to a part (e.g., the head) of a user's body, and a sensor 130. At least one of the components of the wearable electronic device 100 according to an embodiment may be the same as or similar to at least one of the components of the wearable electronic device 100 of FIG. 8, and a redundant description thereof will be omitted below.

According to an embodiment, the wearable electronic device 100 may be electrically or operatively connected to an external server 160. For example, the wearable electronic device 100 may be electrically or operatively connected to the external server 160 through wireless communication, and thus, data may be transmitted between the wearable electronic device 100 and the external server 160.

The external server 160 may receive sensing data on the peripheral environment of the wearable electronic device 100 from the sensor 130 of the wearable electronic device 100. For example, the processor 140 may receive image data on a peripheral object of the wearable electronic device 100 from the sensor 130 through the interface 155.

According to one embodiment, the external server 160 may use, as an input image, the image data for the peripheral object (e.g., the hand part of the human body) received from the sensor 130 of the wearable electronic device 100 to acquire location information about the joint point of the peripheral object in the input image and location information on the model vertex thereof. In this case, the external server 160 may serve as the feature configuration device 52 and/or the estimation device 53 of FIG. 5.

The external server 160 may acquire a global feature from an input image acquired by the sensor 130 of the wearable electronic device 100 and may acquire a location code of a peripheral object from a template model stored in the memory of the external server 160. In this case, an operation of acquiring a global feature from the above-described input image and acquiring a location code of an object from the template model in the external server 160 may be substantially the same as or similar to operation S101 of FIG. 1, and a redundant description thereof will be omitted below.

In addition, the external server 160 may determine a local area feature of the peripheral object, based on the global feature of the input image and the location code of the peripheral object in the template model. For example, the external server 160 may utilize the global feature of the input image and the location code of the peripheral object in the template model to determine the local area feature of the peripheral object including the feature representation of the joint point and model vertex.

In this case, the operation of determining the local area feature of the peripheral object of the external server 160 may be substantially the same as or similar to operation S102 of FIG. 1, and a redundant description thereof will be omitted below.

In addition, the external server 160 may acquire location information of the joint point of the peripheral object and location information of the model vertex in the input image thereof, based on the local area feature of the peripheral object. For example, the external server 160 may group local area features based on positional relationships between local areas of the peripheral object and perform encoding based on grouping results to determine location information of joint points of the peripheral object and location information of model vertices in the input image.

In this case, an operation of acquiring the location information of the joint point and the location information of the model vertex of the peripheral object of the external server 160 may be substantially the same as or similar to operation S103 of FIG. 1, and redundant descriptions thereof will be omitted below.

According to an embodiment, the external server 160 may generate an augmented reality image based on the location information of the joint point of the peripheral object and the location information of the model vertex thereof, which are determined through the above-described operations, and transmit the generated augmented reality image to the wearable electronic device 100. For example, the external server 160 may transmit, to the wearable electronic device 100, the augmented reality image generated based on location information of the joint point of the peripheral object of the wearable electronic device 100 and location information of the model vertex thereof.

The wearable electronic device 100 may display the augmented reality image received from the external device 150 through the lens 110 (or “display”). The wearable electronic device 100 may further include optical components for emitting light including data for the augmented reality image and adjusting the movement path of the emitted light. The wearable electronic device 100 may emit light including data on the augmented reality image received from the external device 150 through optical components, and may allow the emitted light to reach the lens 110.

As the light including the data for the augmented reality image reaches the lens 110, the augmented reality image may be displayed on the lens 110, and the wearable electronic device 100 may provide the augmented reality image to the user (or the wearer) through the above-described process.

In an object pose and model estimation method and device according to an example embodiment of the disclosure, first, a global feature of an input image, and a location code including coordinates of a joint point and a model vertex of an object in a template model are acquired, a local area feature of the object is determined based on the global feature of the input image and the location code of the object in the template model, and location information for the joint point of the object in the input image and location information for the model vertex in the input image based on the local area feature of the object are acquired, to thereby improve an accuracy in estimation of object pose and model.

In an example embodiment of the disclosure, in the method of estimating a pose and a model of an object, a global feature of an input image and a location code of the object in a template model are used as input data of an artificial intelligence model, to thus acquire poses and models of the output object.

The artificial intelligence model may be acquired through training. Here, the term “acquired through training” refers to acquiring a predetermined operating rule or artificial intelligence model by training a basic artificial intelligence model having a plurality of pieces of training data through algorithm training, and the operating rule or artificial intelligence model is configured to execute necessary features (or purposes).

As an example, the artificial intelligence model may include a plurality of neural network layers. Each of the plurality of neural network layers includes a plurality of weights, and neural network calculation is performed through calculation between the calculation result of the previous layer and the plurality of weights.

Visual understanding is the same as human vision, which is a technique for identifying and processing objects, such as object identification, object tracking, image retrieval, human identification, scene identification, three-dimensional reconstruction/positioning, or image augmentation.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A method of estimating a pose of an object and a model of the object, the method comprising:
acquiring a global feature of an input image and a location code of an object in a template model, the location code comprising location information for a joint point of the object and location information for a model vertex;
determining a local area feature of the object, based on the global feature of the input image and based on the location code of the object in the template model; and
determining location information for the joint point of the object in the input image and location information for the model vertex in the input image, based on the local area feature of the object.

2. The method of claim 1, wherein
the determining of the local area feature of the object comprises:
dividing the global feature into a plurality of sub-features that do not cross each other based on a local area of the object; and
determining the local area feature of the object, based on the plurality of sub-features and based on the location code of the object in the template model.

3. The method of claim 2, wherein the local area feature comprises a feature representation of the joint point and the model vertex of the local area of the object.

4. The method of claim 3, wherein
the determining of the local area feature of the object comprises acquiring the local area feature of the object by connecting the joint point in the local area corresponding to each sub-feature among the plurality of sub-features with coordinates of the model vertex.

5. The method of claim 1, wherein the determining of the location information for the joint point of the object in the input image and the location information for the model vertex in the input image comprises:
grouping local area features of the object into a plurality of groups of local area features based on positional relationships among local areas of the object; and
determining the location information for the joint point of the object in the input image and the location information for the model vertex in the input image by performing encoding on the basis of a grouping result.

6. The method of claim 5, wherein
the grouping the local area features of the object based on the positional relationships among the local areas of the object comprises:
encoding each local area feature of the local area features of the object through a first transformer network; and
based on the positional relationship between the local areas of the object, acquiring the plurality of groups of features by grouping the encoded local area features.

7. The method of claim 6, wherein the grouping of the encoded local area features based on the positional relationships among the local areas of the object comprises:
grouping the encoded local area features according to a predetermined grouping rule based on the positional relationships among the local areas of the object, or
grouping the encoded local area features through a grouping network based on the positional relationships between the local areas of the object.

8. The method of claim 5, wherein
the determining of the location information for the joint point of the object in the input image and the location information for the model vertex in the input image comprises:
encoding each group of the plurality of groups of local area features through a second transformer network; and
acquiring location information for at least one joint point of the object in the input image and location information for at least one model vertex in the input image by encoding the plurality of encoded groups of features through a third transformer network.

9. The method of claim 1, wherein the object comprises at least one of a human body, an animal, a part of the human body, and a part of the animal.

10. The method of claim 9, wherein the part of the human body comprises a hand part of the human body, and the local area of the object comprises at least one of a palm, a thumb, a forefinger, a middle finger, a ring finger, and a little finger.

11. A device for estimating a pose of an object and a model of the object, the device comprising:
a data acquisition device configured to acquire a global feature of an input image and a location code of an object in a template model, wherein the location code comprises location information for a joint point of the object and location information for a model vertex of the object;
a feature configuration device configured to determine a local area feature of the object, based on the global feature of the input image and based on the location code of the object in the template model; and
an estimation device configured to acquire location information for the joint point of the object in the input image and location information for the model vertex in the input image, based on the local area feature of the object.

12. The device of claim 11, wherein the feature configuration device is configured to:
divide the global feature into a plurality of sub-features, which do not cross each other, based on a local area of the object; and
configure the local area feature of the object, based on the plurality of sub-features and based on the location code of the object in the template model.

13. The device of claim 12, wherein the local area feature comprises a feature representation of the joint point and the model vertex in the local area of the object.

14. The device of claim 13, wherein the feature configuration device is configured to:
acquire the local area feature of the object by connecting each sub-feature among the plurality of sub-features with coordinates of the joint point and the model vertex in a respective local area of the object, the respective local area corresponding to the sub-feature.

15. The device of claim 11, wherein the estimation device is configured to:
group local area features of the object into a plurality of groups of local area features based on positional relationships among the local areas of the object, and
determine the location information for the joint point of the object in the input image and the location information for the model vertex in the input image by performing encoding on the basis of a grouping result.

16. The device of claim 15, wherein the estimation device is configured to:
encode each local area feature of the local area features of the object through a first transformer network, and
acquire the plurality of groups of features by grouping the encoded local area features, based on a relationship between local areas of the object.

17. The device of claim 15, wherein the estimation device is configured to:
group the encoded local area features according to a predetermined grouping rule based on positional relationships among the local areas of the object, or
group the encoded local area features through a grouping network based on the positional relationships between the local areas of the object.

18. The device of claim 15, wherein the estimation device is configured to:
encode each group of the plurality of groups of local area features through a second transformer network, and acquire location information for at least one joint point of the object and location information for at least one model vertex in the input image by encoding the plurality of encoded groups of features through a third transformer network.

19. The device of claim 11, wherein the object comprises at least one of a human body, an animal, a part of the human body, and a part of the animal.

20. The device of claim 19, wherein the part of the human body comprises a hand part of the human body, and the local area of the object comprises at least one of a palm, a thumb, a forefinger, a middle finger, a ring finger, and a little finger.
